(19) United States
(12) Patent Application Publication
(10) Pub. No.: US 2022/0334948 A1
(43) Pub. Date: Oct. 20, 2022

(54) METHODS AND APPARATUS TO IMPROVE PERFORMANCE DATA COLLECTION OF A HIGH PERFORMANCE COMPUTING APPLICATION

(71) Applicant: Intel Corporation, Santa Clara, CA (US)

(72) Inventors: David Ozog, Ashland, MA (US); Md. Wasi-ur Rahman, Bee Cave, TX (US); James Dinan, Hudson, MA (US)

(21) Appl. No.: 17/856,148

(22) Filed: Jul. 1, 2022

Related U.S. Application Data
(63) Continuation of application No. 16/286,095, filed on Feb. 26, 2019.

(51) Int. Cl. G06F 11/34; G06F 11/30; G06F 13/40; G06F 11/36

(52) U.S. Cl. CPC G06F 11/3485; G06F 11/3041; G06F 13/4027; G06F 11/3612

(57) ABSTRACT

Methods, apparatus, systems and articles of manufacture to improve performance data collection are disclosed. An example apparatus includes a performance data comparator of a source node to collect the performance data of an application of the source node from the host fabric interface at a polling frequency; an interface to transmit a write back instruction to the host fabric interface, the write back instruction to cause data to be written to a memory address location of memory of the source node to trigger a wake up mode; and a frequency selector to: start the polling frequency to a first polling frequency for a sleep mode; and increase the polling frequency to a second polling frequency in response to the data in the memory address location identifying the wake mode.

### RELATED APPLICATIONS

This patent arises from a continuation of U.S. patent application Ser. No. 16/286,095, which was filed on Feb. 26, 2019. U.S. patent application Ser. No. 16/286,095 is hereby incorporated herein by reference in its entirety. Priority to U.S. patent application Ser. No. 16/286,095 is hereby claimed.

### FIELD OF THE DISCLOSURE

This disclosure relates generally to processors, and, more particularly, to methods and apparatus to improve performance data collection of a high performance computing application.

### BACKGROUND

High performance computing (HPC) is utilized in various types of technologies to perform complex tasks. In HPC systems, individual computers (e.g., nodes) may be configured in clusters. Each computer may have multiple cores capable of running multiple processes. HPC utilizes multiple nodes of a cluster together to solve a problem larger than a single computer can easily solve. HPC systems run based on instructions from HPC applications. An HPC application includes instructions to be executed by the nodes of a HPC system. Most HPC applications include computation and communication phases that execute at alternate times. Instructions corresponding to initialization of variables, preprocessing data, parsing data, semantic analysis, lexical analysis, etc. are executed during computational phases. Instructions corresponding to communication with other nodes in a HPC system that are executed during communication phases. Performance analysis tools may be used by HPC software developers to collect performance data corresponding to communication operations of an HPC application to improve the performance of the application, identify errors, identify issues, etc.

### BRIEF DESCRIPTION OF THE DRAWINGS

FIG. 1 is a block diagram of an example implementation of an example central processing unit in a node of a high performance computing system.

FIG. 1A is an example of write back instructions that may be generated by the example collector of FIG. 1.

FIG. 2 is a block diagram of an example implementation of the example collector of FIG. 1.

FIG. 3 is a block diagram of an example implementation of the example triggered operations circuitry of FIG. 1.

FIG. 4 is a flowchart representative of example machine readable instructions that may be executed to implement the collector of FIGS. 1 and/or 2.

FIG. 5 is a flowchart representative of example machine readable instructions that may be executed to implement the host fabric interface of FIGS. 1 and/or 3.

FIG. 6 is a block diagram of an example processor platform structured to execute the instructions of FIG. 4 to implement the example collector of FIGS. 1 and/or 2.

FIG. 7 is a block diagram of an example processor platform structured to execute the instructions of FIG. 5 to implement the example collector of FIGS. 1 and/or 3.

The figures are not to scale. In general, the same reference numbers will be used throughout the drawing(s) and accompanying written description to refer to the same or like parts.

Descriptors “first,” “second,” “third,” etc. are used herein when identifying multiple elements or components which may be referred to separately. Unless otherwise specified or understood based on their context of use, such descriptors are not intended to impute any meaning of priority or ordering in time but merely as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components

### DETAILED DESCRIPTION

High performance computing (HPC) systems include multiple processing nodes working together to perform one or more tasks based on instructions of an HPC application. As used herein, a “node” is defined to be an individual computer (e.g., a service, a personal computer, a virtual machine, etc.) that is part of an HPC cluster. A node may include one or more CPUs. Each CPU may include one or more processor cores. Each node of a HPC system may exhibit a computation phase (e.g., for performing computations locally) and a communication phase (e.g., for transmitting data to one or more other nodes in the HPC system). To implement communication operations between nodes, HPC nodes include one or more hardware-based host fabric interfaces (HFIs) (e.g., network interface cards (NICs)) designed to transmit (e.g., broadcast) data to one or more of the other nodes in the HPC system to write data (e.g., using an remote direct memory access (RDMA) operation) from the first node into the memory of one or more of the other nodes. In known systems, the first node transmits instructions to the HFI to cause transmission of data to the other node(s) immediately or after some event(s) occur(s). The HFI includes hardware event counters to track when certain events occur. Accordingly, when the instruction from the CPU of the first node corresponds to a triggered operation (e.g., an instruction to transmit data after some event occurs), the HFI can monitor the count of a corresponding event counter to identify when to transmit the data identified by instructions from the CPU of the first node to one or more of the other nodes in the HPC system.

Some CPUs in one or more nodes of known HPC systems utilize a software-based collector or collector thread monitor performance of the application running on one or more of the main executor threads of a CPU in the node. In this manner, the collector thread can provide useful information to a user and/or developer to improve (e.g., optimize) the application. The collector may collect performance data (e.g., pull data from hardware performance counters) to measure and/or improve (e.g., optimize) the progress of one or more communication operations. The collector, or another component, can process the performance data to identify any potential issue(s) corresponding to communication operations. The collector may continuously measure the performance of the communication operations by polling hardware performance counters at execution time. However, such polling consumes resources of a CPU in the node, which is a valuable commodity for HPC systems. Accordingly, such polling may degrade overall HPC application performance. Although the polling performed by the collector is important for measuring progress of communication operations (perhaps justifying a degree of degradation of overall performance), it may degrade the overall performance if polling is enabled during the computation phase of an application.

Some known techniques reduce performance data collection by sampling or polling in response to an application's runtime behavior. The polling interval can be increased if no changes are observed for a threshold period of time and/or the polling interval can be decreased when an event of interest occurs. Such techniques adapt the sampling frequency online to increase (e.g., maximize) the information content of the samples and reduce (e.g., minimize) the collection of low-information samples, to reduce the overhead associated with performance monitoring. However, such techniques may miss critical events that occur spontaneously at the beginning and/or end of a program phase. Additionally, tuning polling parameters is difficult because the optimal values depend on various complex characteristics (e.g., system configurations, available resources, dynamic behavior of an application, etc.). Additionally, such techniques restrict the actions that the collector or other tool of the CPU can take during collection (e.g., a tool may not be able to allocate memory, perform input/output (I/O) operations needed to capture samples, etc.).

Examples disclosed herein improve performance data collection for HPC applications by leveraging the host fabric interface (HFI). For example, although HFIs are typically structured to forward data to other nodes in a HPC system (e.g., by writing data into memory of the other nodes for collective communication operations), examples disclosed herein instruct the HFI to perform a triggered put operation (e.g., a write data operation) to write data back to the memory of the node forwarding the data (i.e., the node that includes the collector) as opposed to another node in the HFI. The triggered put operation occurs in response to one or more conditions corresponding to communication phase events that will trigger a wakeup of the collector. In this manner, the collector can enter a sleep mode during computation phases to reduce or cease polling (e.g., to conserve CPU resources) while the host fabric interface tracks one or more events using hardware event counters. The triggered put operation causes a write operation back to the memory (e.g., a user memory space) of the node originating the triggered put operation at a memory address location specified by the collector. In this manner, when one or more events specified for monitoring occur, the host fabric interface identifies the condition and writes to the memory address location of the node specified by the collector. In sleep mode, the collector monitors the memory address location to identify when the host fabric interface writes to the memory address location, thereby indicating the condition has been satisfied (e.g., the one or more triggering events have occurred). In response to the collector identifying that the data in the memory address location has been updated, the collector wakes up and increases the polling frequency and/or restarts the polling process. Because monitoring one or more memory addresses uses less CPU resources than polling the event counters directly, examples disclosed herein significantly reduce the amount of CPU resources needed to execute performance data collection of HPC applications. Examples disclosed herein use a direct memory access (DMA) operation to write data into the memory of the source node. As used herein, a DMA operation corresponds to an HFI of source node writing data to memory of the source node and a RDMA operation corresponds to an HFI of a source node writing data to memory of a destination node different than the source node.

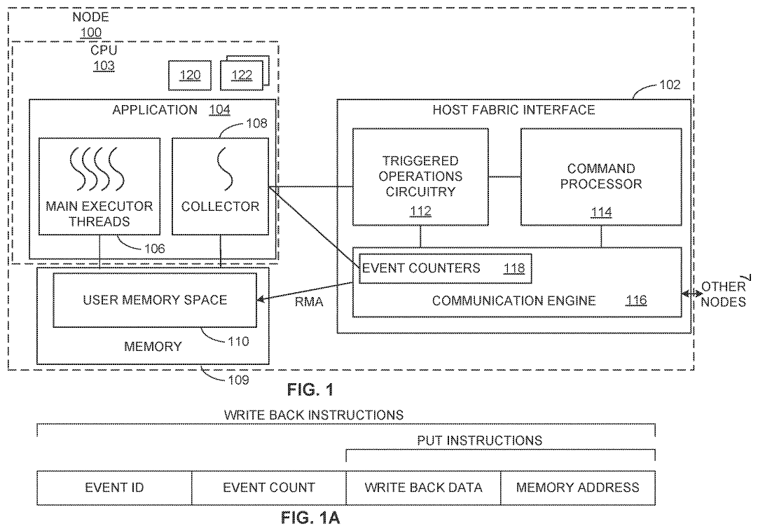

FIG. 1 is a block diagram of an example implementation of an example node 100 of a high performance computing device. Another name of the HFI 102 is a network interface card (NIC). In the example of FIG. 1, the example node 100 includes an example CPU 103 to execute an example application 104. The application 104 is a high performance computing application which includes example main executor threads 106 and one or more collector threads 108. The CPU 103 of FIG. 1 also includes example memory 109. Example user memory space 110 in including in the memory 109. The CPU 103 of this example also includes one or more levels of cache 120 and one or more example processor core(s) 122. Although shown as separate, some or all of the cache may be located in corresponding ones of the cores 122.

The example node 100 of FIG. 1 includes a host fabric interface (HFI) 102. The example HFI 102 includes example triggered operations circuitry 112, an example command processor 114, an example communication engine 116, and example event counters 118. Although FIG. 1 illustrates the event counters 118 with the communication engine 116, the event counters 118 may be located internal or external of the communication engine 116.

The example node 100 of FIG. 1 is an individual computation device that is part of a HPC cluster including other nodes. In examples disclosed herein, the node 100 of FIG. 1 may be referred to as a “source node” because it originates a memory write back instruction to be performed by the HFI to wake a collector on the source node from a sleep state. The example node 100 includes the example CPU 103 and the example memory 109. In some examples, the node 100 may include multiple CPUs. In some examples, there may be a plurality of other nodes in communication with the node 100 (e.g., the source node) via the example HFI 102. In such examples, the plurality of nodes may work together to process data and/or perform a task to solve a problem larger than a single computer can efficiently solve.

The example CPU 103 of FIG. 1 may be an embedded system, a field programmable gate array, a shared-memory controller, a network on-chip, a networked system, and/or any other circuitry that includes a hardware (e.g., semiconductor based) processor, memory, and/or cache. The example CPU 103 utilizes processor resources (e.g., the example cache 120, the register(s) and/or logic circuitry of the example processor core(s) 122) to execute instructions to implement the example application 104.

The example application 104 of FIG. 1 may be some or all of any HPC application exhibiting one or more computation phases and/or one or more communication phases to perform a task in conjunction with other nodes. For example, the application 104 may include instructions to perform particular tasks locally and/or to transmit data to one or more other nodes via the example HFI 102 and/or to access data obtained from one or more of the nodes via the HFI 102. The data from other node(s) may be written to memory via the HFI 102 and accessed there by the node 100.

The example main executor threads 106 of the application of FIG. 1 are software threads and/or software objects that are capable of executing asynchronous tasks and/or autonomously managing a plurality of other threads. The example main executor threads 106 may compile, translate, and/or execute instructions of the example application 104 using the processor resources (e.g., the example cache 120 and/or the example processor core(s) 122) of the example CPU 103. The example main executor threads 106 utilize the user memory space 110 to store data. As described above, the application 104 exhibits computation phase(s) and communication phase(s). The main executor threads 106 interface with the example host fabric interface 102 during some or all of the communication phases to transmit data to one or more other nodes. Additionally, the example main executor threads 106 may obtain data from one or more other nodes via the example user memory space 110 (e.g., when the HFI 102 receives instruction from the other nodes to write data in the user memory space 110 accessible to the main executor nodes).

The example collector 108 of FIG. 1 is a software thread that executes instructions to analyze performance of the example application 104. For example, the collector 108 utilizes processor resources (e.g., the example cache 120 and/or the example processor core(s) 122) of the example CPU 103 to collect performance data to measure the progress of communication operations of the application 104 (e.g., when the application 104 utilizes the HFI 102 to transmit and/or receive data from other nodes). For example, the collector 108 may poll and process event counts from the example event counters 118 to analyze the performance of the communication operations of the application 104. The collector 108 of this example utilizes one or more processor core(s), one or more registers and/or one or more other CPU resources (e.g., the example cache 120 and/or the example processor core(s) 122) to execute and thereby measure the communication operations by polling the event counters 118. During periods of high communication activity, the collector 108 may record information corresponding to a number of pending operations, rate of data transfer, etc., that can be used to generate reports and/or improve (e.g., optimize) communication performance of the application 104. However, polling hardware performance counters (e.g., the event counters 118 of the HFI 102) during a computation phase consumes significant CPU resources. Accordingly, rather than continuously monitoring, the example collector 108 enters into a sleep mode to decrease (e.g., prevent) polling when communication operations are not being executed (e.g., during computation phases). To initiate sleep mode, the example collector 108 of the source node 100 transmits one or more instructions (e.g., a write back instruction) to the example HFI 102 to track one or more events corresponding to communication operations and write a value to a memory address location of the example user memory space 110 accessible to the collector 108 of the source node 100 in response to a threshold number of events occurring. FIG. 1A illustrates an example write back instruction. As shown in FIG. 1A, the write back instruction(s) include: (1) information corresponding to which event(s) to track, (2) the threshold wake up count(s) (e.g., the number of tracked event(s) that should occur to trigger execution of a the write back) and (3) one or more put and/or atomic operation instructions. In some examples, the write back instructions corresponds to writing data in the same memory address. Accordingly, in such examples the write back instructions may not include the memory address (e.g., because the predefined memory address is always the same). In some examples, the put operation is always the same and not included in the write back instructions (e.g., the put operation always corresponds to the same number and/or combination of events). The put operation instructions may include information corresponding to what data to write to the user memory space 110 and/or where to write the date (e.g., a memory address location). When the put operation corresponds to an atomic update, the put operation instructions may include information corresponding to multiple write backs to increment a value at the same location (e.g., thereby allowing the collector to wait until the count of the memory address location to reach a threshold value before waking up). The threshold number of events (e.g., number and/or type of event(s)) may be user defined and/or selected by the collector 108. In some examples, the type(s) of event(s) may correspond to communication events. In this manner, during sleep mode, instead of polling and processing the event counts of the example event counters 118, to thereby consume processor resources (e.g., the example cache 120 and/or the example processor core(s) 122 of the source node), the example collector 108 monitors the memory address location (e.g., one memory location) to identify when the HFI 102 writes data in that memory address location. The communication engine 116 of HFI is programmed by the write back instructions to write to that memory location only when a threshold number of events has occurred, as further described below.

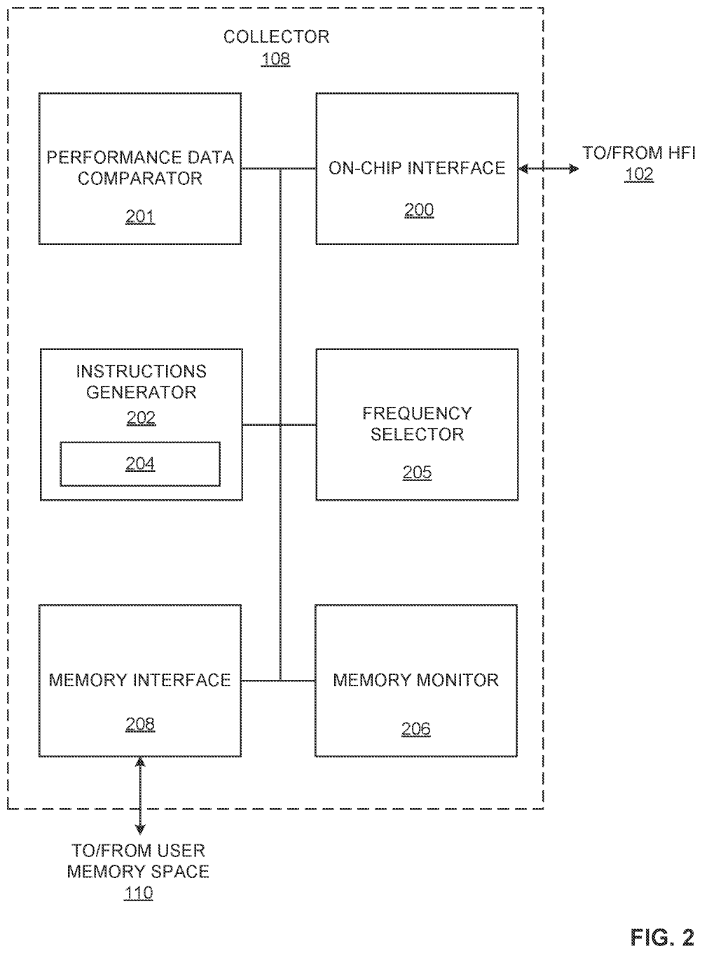

Monitoring a change in a specific memory address location utilizes less processor resources of the example CPU 103 than polling performance data from the example event counters 118. Accordingly, the sleep mode of the collector saves power by allowing CPU resources (e.g., cores) to be powered down. In this manner, the CPU may improve performance by allowing other cores to run at a higher frequency. Additionally, the HFI 102 does not utilize processor resources of the example CPU 103 of the source node. Accordingly, the collector 108 (which executes on the CPU 103 of the source node) can enter sleep mode and wake up based on a trigger from the HFI 102 (e.g., data being written to the memory address location) to thereby utilize less processor resources of the example CPU 103 of the source node, while maintaining overall application performance monitoring by polling when polling is necessary to maintain application performance and preventing polling when polling is not necessary to maintain application performance data. The write back instructions generated by the example collector 108 may include threshold count(s) corresponding to count(s) of the event counters 118 that trigger execution of a put operation. However, because the event counters 118 may be continuously operational, the collector 108 may need to identify the starting (e.g., current) event count of the event counters 118 at the time of receiving the write back instruction(s)to be able to determine when the number of events identified in the write back instructions has occurred. Accordingly, the collector 108 adds the wake up count to the current event count to generate a threshold count (e.g., whose satisfaction triggers the put operation to be executed). For example, if the put operation corresponds to writing data into a memory address location in response to a particular event occurring 5 times, the collector 108 reads the event count of the counter that corresponds to the particular event (e.g., 100). In such an example, the collector 108 adds 5 (e.g., the wake up count specified in the write back instructions) and 100 (e.g., the current event count of the event counter) to generate a threshold count of 105. An example implementation of the example collector 108 is further described below in conjunction with FIG. 2.

The example memory 109 of FIG. 1 is memory of the example CPU 103. However, it could alternatively be memory external to, but accessible to the CPU (e.g., off chip memory). Some of memory 109 is available for reading and/or writing data. For instance, the example memory 109 includes the example user memory space 110 which is reserved for and/or accessible to the application 104 to use (e.g., read from and/or write to). The user memory space includes memory space to store data that can be written to and/or read by another component. For example, the communication engine 116 may perform a direct memory access (DMA) and/or remote DMA (RDMA) operation to write data into one or more memory address locations (e.g., memory address locations) of the user memory space 110.

The HFI 102 of the example of FIG. 1 facilitates communication of data between nodes of an HPC system. When the example HFI 102 receives write back instruction(s) from the example collector 108, the HFI 102 processes the write back instruction(s) to identify (A) the put/atomic operation and its arguments (e.g., the data to be written and the location of memory to be written to), and (B) the trigger condition (e.g., one or more event(s) and/or counter(s) to monitor, and/or the number of the corresponding event(s) that need to occur to trigger execution of the put operation). The HFI 102 queues the put operation in local memory and/or a register and monitors event counter(s) corresponding to the event(s) and/or count(s) specified in the write back instruction(s). The HFI 102 monitors the event counters to determine when the event count(s) reaches a threshold corresponding to the number of events(s) (e.g., the wake up count(s)) specified in the write back instructions. In response to the HFI 102 determining that the event count(s) satisfied a threshold(s), the put operation is transmitted to a command processor to cause the put operation to be executed by the command processor. Execution of the put operation includes the communication engine 116 of the HFI 102 performing a DMA/RDMA operation to write data into a memory address location (e.g., specified in the put operation) of the user memory space 110 of the source node 100. In this manner, the collector 108 can identify when the number of events corresponding to the write back instructions has occurred without polling the event counters directly. Such events may correspond to completion of an outbound operation to another node, message arrival from another node, etc.

The example HFI 102 includes triggered operations circuitry 112 to receive write back instruction(s) from the example collector 108 and to track one or more of the example event counters 118 based on the write back instruction(s). Based on the write back instructions, the example triggered operations circuitry 112 performs an action (e.g., transmit a queued put operation) in response to the event count of one of more of the event counters 118 reaching a threshold count. For example, the collector 108 may transmit write back instruction(s) including an operation (e.g., a triggered put operation, a triggered atomic operation, and/or an instruction to perform one or more such operations) to the triggered operations circuitry 112. The write back instruction(s) further indicate that the operation (e.g., read, write, etc.) is to occur in response to one or more events. For example, the write back instruction(s) may identify a triggered put operation that instructs and/or causes the communication engine 116 of the HFI 102 to write data to a particular memory address location in response to a triggered event (e.g., more than a threshold number of event(s) occurring as measured by the event counters 118). A triggered atomic operation instructs and/or causes the communication engine 116 of the HFI 102 to write to and/or update a particular memory address location without allowing other intervening instructions. The triggered operations circuitry 112 queues (e.g., stores in a register) the put operation (e.g., a memory write operation corresponding to a memory address location) and monitors the example event counters 118 until the threshold number of events occur. For example, when the triggered operations circuitry 112 determines that more than a threshold number of the particular event has occurred, the queued put operation is released, thereby causing the triggered operation to be executed (e.g., by transferring the operation from the queue of the triggered operations circuitry 112 to the core of the command processor 114 to be executed).

As described above, the write back instruction(s) may identify a number of events (e.g., a wake up count) that should occur before causing the triggered operation to be executed based on the threshold wake up count(s) of the write back instructions. The triggered operation circuitry 112 monitors the event counter until the event count satisfies (e.g., equals, reaches, exceeds etc.) the threshold count (e.g., 105). In response to the satisfying of the threshold count, the triggered operations circuitry 112 launches (e.g., transmits) the queued put operation to the example command processor 114 to be executed to cause the communication engine to write data to memory at the source node. In some examples, rather than adding the wake-up count (e.g., 5) to the current event count (e.g., 100), the triggered operation circuitry sets the threshold value directly.

The example command processor 114 of the example of FIG. 1 is a hardware (e.g., semiconductor based) processor including logic circuitry that may be programmed to perform operations (e.g., arithmetic operations, Boolean logic operations, etc.) in response to signals and/or data from the example triggered operation circuitry 112. As described above, the example triggered operation circuitry 112 transmits an operation that was queued in the triggered operation circuitry 112 to the command processor 114 in response to a threshold number of specific events occurring. Once the operation is obtained from the queue of the triggered operation circuitry 112, the command processor 114 executes the triggered operation (e.g., on one of its cores). For example, if the triggered operation is a put operation, the command processor 114 processes the put operation to determine the data to write and/or a memory location and instructs the communication engine 116 to perform a write command (e.g., using a direct memory access (DMA) or remote DMA (RDMA) operation) to a particular memory address location (e.g., identified in the triggered operation). In such an example, the command processor 114 instructs the communication engine 116 to perform a DMA or RDMA operation to write data to the memory address location specified in the put operation. As described above, conventional systems utilize the RDMA operation to write to memory addresses of different nodes. For example, conventionally, when a source node (e.g., node 100) utilizes the HFI 102, the source node (e.g., node 100) utilizes the HFI 102 to perform a RDMA operation to write to a memory address of a different node (e.g., not the source node 100 that issued the write back instructions). However, examples disclosed herein utilize the DMA operation to write back to the example user memory space 110 of the node 100 originating the write back instructions (e.g., the source node) to trigger wake up of the example collector 108 on the source node 100. The collector 108 may then commence monitoring. For example, the source node (e.g., node 100) instructs the HFI 102 to utilize the DMA operation to write to user memory space of the source node to signify that the collector of the source node should wake-up. This event count is selected so that the wake up of the collector occurs at the end of the computation phase and the beginning (or just before the beginning) of the communication phase. In this manner, the collector 108 is able to poll performance data during communication phases and not poll during computation phases, thereby conserving resources (e.g., the example cache 120 and/or the example processor core(s) 122) of the source node and avoiding burdening these resources during computational phases.

The example communication engine 116 of FIG. 1 manages the example event counters 118. For example, the example communication engine 116 increments the event counters 118 in response to an event that occurs within the HFI (e.g., within communication engine 116). For example, the monitored event may be completion of an outbound operation to another node, message arrival from another node, etc. Additionally, the example communication engine 116 transmits instructions (e.g., an DMA operation) to cause the communication engine 116 of the HFI 102 to write to memory (e.g., the example user memory space 110) of the node 100. These write back operates as a reset instruction (e.g., to wake the collector). The example communication engine 116 may also write to memory of different nodes (e.g., to transfer data to one or more other node(s)).

The example event counters 118 of FIG. 1 can be used to monitor any or all of a wide range of events (e.g., completion of output operations, message arrivals, clock cycles, number of bytes transmitted or received from other nodes, etc.). The event counters 118 may be registers, memory on the HFI 102, a content addressable memory (CAM) structure, etc. The monitored events may be performed by the command processor 114 and/or the communication engine 116. The communication engine 116 reserves a particular event counter 118 for a particular event. For example, the communication engine 116 may increment a first counter of the event counters 118 for a completion of an outbound operation, a second counter of the event counters 118 for a message arrival, etc. In this manner, the triggered operations circuitry 112 can track when different events occur based on the event count of the different event counters 118. Moreover, different event trigger thresholds may be applied to different counters (e.g., 5 outbound operations versus 10 message arrivals). Furthermore, the write back to the source node may only occur when 2 or more events are satisfied (e.g., 2 or more outbound operations and 10 or more message arrivals). Additionally or alternatively, the example write back to the source node may occur when two or more events are satisfied (e.g., when 2 or more outbound operations or 10 or more message arrivals). Additionally or alternatively, the write back to the source node may occur based on any combination of the above (e.g., (Event A and Event B) or (Event C)).

FIG. 2 is a block diagram of an example implementation of the collector 108 of FIG. 1. The example collector 108 of FIG. 2 includes an example on-chip interface 200, an example performance data comparator 201, an example instructions generator 202, an example adder 204, an example frequency selector 205, an example memory monitor 206, and an example memory interface 208.

The example on-chip interface 200 of FIG. 2 communicates with the example HFI 102 of FIG. 1. For example, while the example collector 108 is awake, the example on-chip interface 200 polls the example event counter 118 to generate communication performance data of the example application 104. To initiate sleep mode, the example on-chip interface 200 transmits write back instructions (e.g., including a triggered put operation or a triggered atomic operation, which includes the write back address, event(s) to be monitored, and a number(s) of the event(s) corresponding to the trigger) that cause the communication engine 116 of the example HFI 102 to write to the specified memory address location in response to one or more threshold number(s) of one or more event(s) occurring. As described above, during sleep mode of the collector, the example on-chip interface 200 stops polling the event counter 118 or reduces the polling frequency to conserve processor resources.

The example performance data comparator 201 of FIG. 2 compares performance data corresponding to event counts of the example event counters 118. For example, the performance data comparator 201 may determine that the example collector 108 should enter sleep mode when the event counters 118 remain stable (e.g., are not being incremented) for a threshold duration of time. The threshold duration of time may be preset and/or customizable based on user and/or manufacturer preferences. In some examples, the application 104 or another component may instruct the example collector 108 to enter into sleep mode.

In response to determining that sleep mode should be initiated, the example instructions generator 202 of FIG. 2 generates write back instructions corresponding to how and when the collector 108 should wake up. For example, the instructions generator 202 generates one or more write back instructions such as the instance of FIG. 1A that instruct the communication engine 116 of the HFI 102 to write to a particular memory address of the example user memory space 110 after a threshold number of events occurs. Accordingly, the instructions generator 202 generates the write back instruction(s) to include a triggered operation to be launched in response to one or more events, the threshold count(s) of the event counter(s) corresponding to number of times the one or more events can occur before triggering the wake-up, and/or a memory address location for the communication engine 116 of the HFI to write to, thereby signaling the wake-up. The events, number of events, and/or memory address may be preset and/or customizable based on user and/or manufacturer preferences. The example instructions generator 202 determines the threshold count(s) of the event count(s) to trigger a wake-up using the example adder 205.

The example adder 204 of FIG. 2 determines what threshold count(s) by adding the one or more wake up counts (e.g., the wake up count(s) corresponding to how many events need to occur to trigger a wake-up) to the event counts of the corresponding event counters to generate threshold count(s). For example, the instructions generator 202 may instruct the on-chip interface 200 to identify the current count(s) of one or more event counters that correspond to the one or more events to be tracked. As described above, because the event counters 118 track a variable number, in order for the triggered operation circuitry 112 to determine when the wake up count specified in the write back instructions has been satisfied, the triggered operation circuitry 112 needs to have a baseline for when the event counters will correspond to the specified wake up count. Accordingly, the example instructions generator 202 determines the current event count of the event counters 118 corresponding to the predefined events and the adder 206 adds the current event count to the corresponding wake up count. For example, if a wake-up protocol corresponds to a wake up count of “3” in association with message arrivals, the adder 206 adds the event count (e.g., 100) of the event counter corresponding to message arrivals to the corresponding wake up count (e.g., 3) to generate a threshold count (e.g., 103).

To enter sleep mode, the example frequency selector 205 of FIG. 2 adjusts (e.g., decreases) the polling frequency (e.g., the frequency that the collector 108 polls the event counters 118 for performance data) from a first frequency (e.g., corresponding to an awake-mode frequency) to a second frequency (e.g., corresponding to sleep mode frequency). The second frequency is slower than the first frequency, thereby conserving processor resources of the example CPU 103. In some examples, the second frequency is a zero frequency corresponding to no polling. In response to a wake-up trigger (e.g., the example memory monitor 206 determining that allocated memory has been written to), the example frequency selector 205 increases the frequency from the second frequency back to the first frequency or any other frequency that is faster than the second frequency. For example, the frequency selector 205 may include a circuit (e.g., logic gate(s), switch(es), such as one or more transistors properly biased from a power source via appropriate circuitry (e.g., resistors capacitors, and/or inductors), and/or multiplexer(s)) to switch between frequencies for sleep mode and awake mode.

Once in sleep mode, the example memory monitor 206 monitors the selected memory address location included in the write back instructions that the HFI will write to when the threshold number of event(s) has been satisfied to trigger a wake-up of the collector 108. The example memory monitor 206 monitors the value stored in the selected memory address location until the value changes. For example, the memory monitor 206 performs a read operation to access (e.g., using the example memory interface 208), the data stored in the selected memory address of the example user memory space 110. In response to the value changing (e.g., the read value of the data stored in the selected memory address being different from the initial stored value at the selected memory address and/or being equal to a predetermined values (e.g., logic 1) as determined by a comparator or the like in the memory monitor 206), the collector 108 wakes up (e.g., the frequency selector 205 resumes the polling protocol of the example event counters 118 of FIG. 1 and/or increases the polling frequency of the polling protocol). In some examples, the memory monitor 206 sets (e.g., writes) the data in the selected memory address location to a preset value (e.g., ‘0’) before or when sleep mode is being initiated. In this manner, the memory monitor 206 ensures that the value written in the selected memory address location to trigger the wake up is different than the initial stored value at the selected memory address location.

The example memory interface 208 of FIG. 2 accesses data stored in the example user memory space 110 and transmits the accessed data to the example memory monitor 206 to determine when to wake up the example collector 108. Additionally, in some examples, the memory interface 208 writes data into the selected memory address location of the user memory space 110 (e.g., based on instructions from the memory monitor 206).

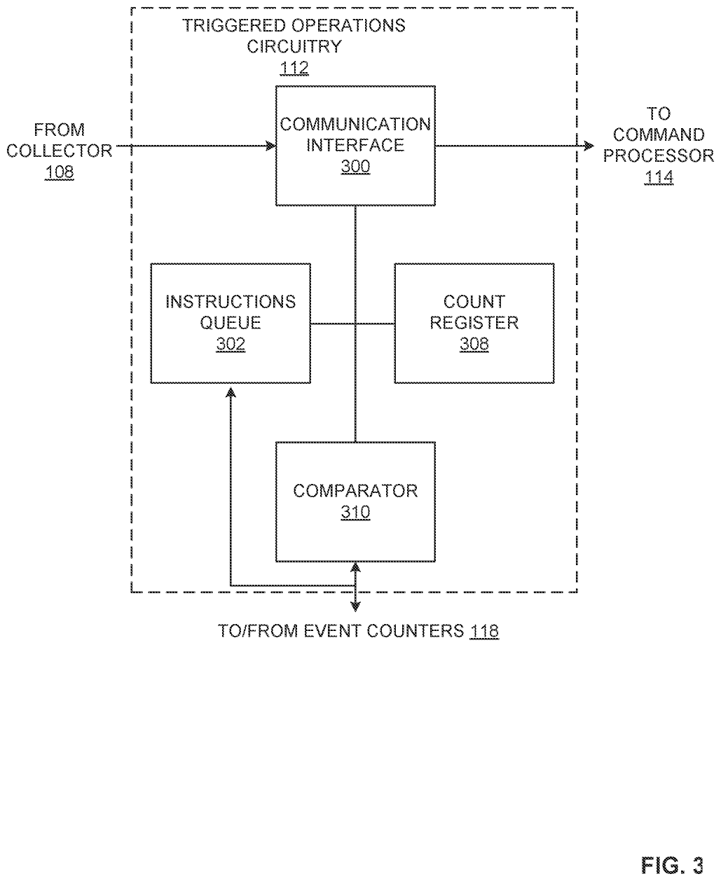

FIG. 3 is a block diagram of an example implementation of the triggered operations circuitry 112 of FIG. 1. The example triggered operations circuitry 112 of FIG. 3 includes an example communication interface 300, an example instructions queue 302, an example threshold register 308, and an example comparator 310.

The example communication interface 300 of FIG. 3 obtains one or more write back instruction(s) from the example collector 108 of the node 100 of FIG. 1. As described above, the write back instruction(s) includes one or more operations (e.g., put operation(s)) including a memory location and/or data to write to the memory location, one or more events and/or event counts to monitor, and/or the threshold count(s) to trigger the transmission of the put operation to the example command processor 114 of FIG. 1. Additionally, in response to the trigger from the example comparator 310 (e.g., corresponding to when the number of the one or more events occurs), the communication interface 300 transmits the one or more put operations corresponding to the obtained write back instructions and stores in the example instructions queue 302. Additionally, the example communication interface 300 stores the threshold count(s) in the example threshold count register(s) 308.

The example instructions queue 302 of FIG. 3 stores the one or more put operations specified in the obtained write back instruction(s). In some examples, the queue 302 will release (e.g., pop, remove, etc.) the one or more queued put operations in response to a trigger from the comparator 310. The released put operation is transmitted to the command processor 114 using the example communication interface 300. In some examples, if the write back instructions correspond to multiple events (i.e. a compound trigger corresponding to when two or more events have occurred), the comparator 310 may output a single trigger when all the multiple events have occurred. In response, the instructions queue 302 may pop out all of the stored put operations (which may be one or more instructions) to be transmitted to the command processor 114. In other examples, if the write back instructions correspond to multiple events and the put operations corresponding to different events, the comparator 310 may output different triggers for the different events and, in response to one of the triggers, the instructions queue 302 may pop the put operation(s) corresponding to a specific event to be transmitted to the command processor 114. For example, there may be one or more logic gate and/or other logic circuitry structured, programmed, and/or fixed to determine when the multiple event and/or complex combination of events occurs to trigger the release of one or more put operations from the queue 302. In some examples, there are multiple instructions queues 302 corresponding to multiple comparators 310 in combination with other logic circuitry (e.g., logic gates, registers, flip flops, etc.) and/or processors programmed to perform triggered operations, such that particular comparison(s) correspond to the launching of particular operation(s) of corresponding queue(s) 302.

The example comparator 310 of FIG. 3 accesses the event count(s) of the event counter(s) 118 corresponding to the event(s) of the threshold register 308 (e.g., the events specified in the write back instructions) and compares the event count(s) to the corresponding threshold count(s) stored in the threshold register 308. When the write back instruction(s) correspond to one event, the comparator 310 will output a triggered signal to the example instructions queue 302 when the event count of the one event satisfies (e.g., is greater than or equal to) the corresponding threshold count, thereby triggering transmission of the queued put operation(s) to the example command processor 114 to be executed. In some examples, the comparator 310 includes multiple comparators and/or performs multiple comparisons for multiple events specified in the write back instructions. In such examples, the comparator 310 may output a single trigger when all of the corresponding event counts meet all of the corresponding threshold counts or the comparator 310 may output different triggers corresponding to a particular event when the corresponding event count meets the corresponding threshold count.

While an example manner of implementing the example collector 108 of FIG. 1 is illustrated in FIG. 2, one or more of the elements, processes and/or devices illustrated in FIG. 2 may be combined, divided, re-arranged, omitted, eliminated and/or implemented in any other way. Further, the example on-chip interface 200, the example performance data comparator 201, the example instructions generator 202, the example adder 204, the example frequency selector 205, the example memory monitor 206, the example memory interface 208, and/or, more generally the example collector 108 of FIGS. 1 and/or 2 may be implemented by hardware, software, firmware and/or any combination of hardware, software and/or firmware. Thus, for example, any of the example event counters 118, the example on-chip interface 200, the example performance data comparator 201, the example instructions generator 202, the example adder 204, the example frequency selector 205, the example memory monitor 206, the example memory interface 208, and/or, more generally the example collector 108 of FIG. 1 and/or could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

While an example manner of implementing the example triggered operations circuitry 112 of FIG. 1 is illustrated in FIG. 3, one or more of the elements, processes and/or devices illustrated in FIG. 3 may be combined, divided, re-arranged, omitted, eliminated and/or implemented in any other way. Further, the example communication interface 300, the example instructions queue 302 the example threshold register 308, the example comparator 310, and/or, more generally the example triggered operations circuitry 112 of FIGS. 1 and/or 3 and/or, the example command processor 114, the example communication engine 116, the example event counters 118, and/or, more generally the example HFI 102 of FIG. 1 may be implemented by hardware, software, firmware and/or any combination of hardware, software and/or firmware. Thus, for example, any of the example communication interface 300, the example instructions queue 302, the example threshold register 308, the example comparator 310, and/or, more generally the example triggered operations circuitry 112 of FIGS. 1 and/or 3 and/or, the example command processor 114, the example communication engine 116, the example event counters 118, and/or, more generally the example HFI 102 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the example event counters 118, the example on-chip interface 200, the example performance data comparator 201, the example instructions generator 202, the example frequency selector 205, the example memory monitor 206, the example memory interface 208, the example collector 108 of FIGS. 1 and/or 2 and/or the example triggered operations circuitry 112, the example command processor 114, the example communication engine 116, the example event counters 118, the example HFI 102 of FIG. 1 and/or the example communication interface 300, the example instructions queue 302, the example threshold register 308, the example comparator 310 of FIG. 3 is and/or are hereby expressly defined to include a non-transitory computer readable storage device or storage disk such as a memory, a digital versatile disk (DVD), a compact disk (CD), a Blu-ray disk, etc. including the software and/or firmware. Further still, the example collector 108 of FIG. 2, the example HFI 102 and/or the example triggered operation circuitry 112 of FIGS. 1, 2, and/or 3 may include one or more elements, processes and/or devices in addition to, or instead of, those illustrated in FIGS. 1, 2, and/or 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

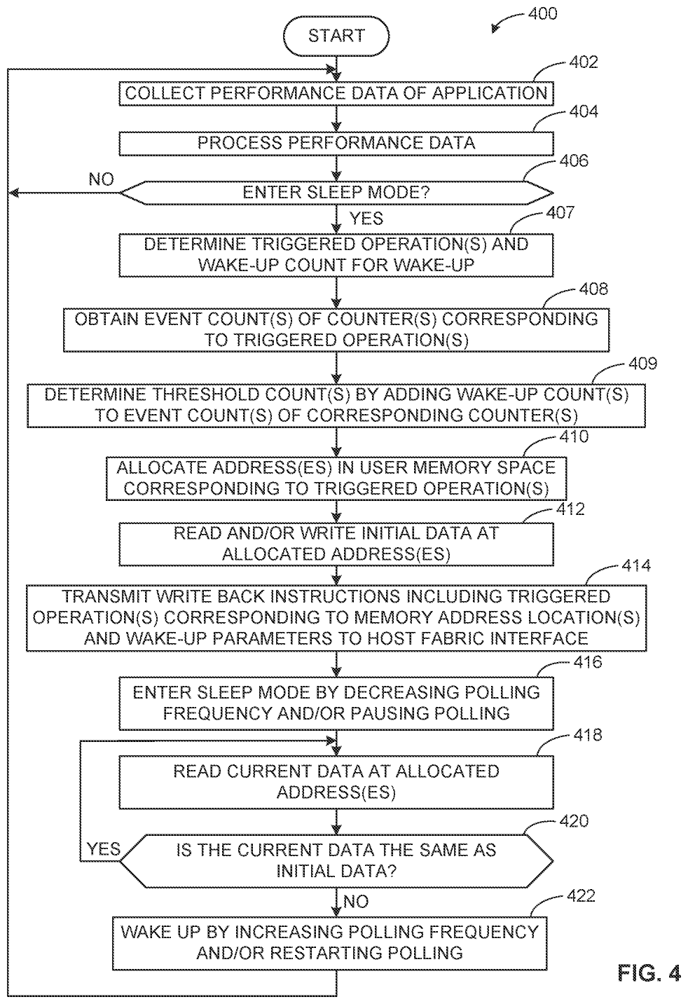

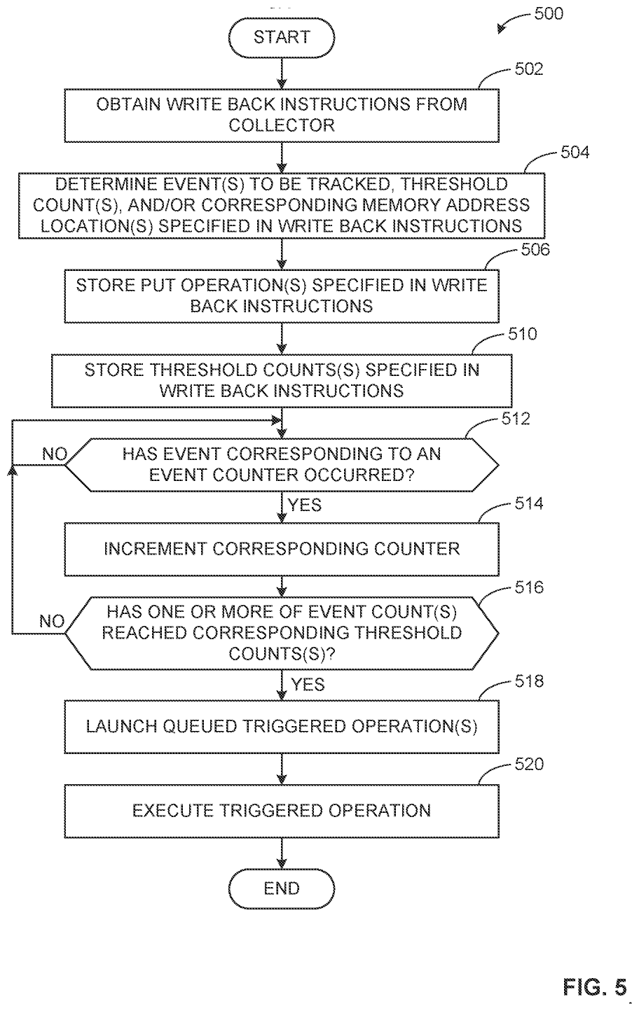

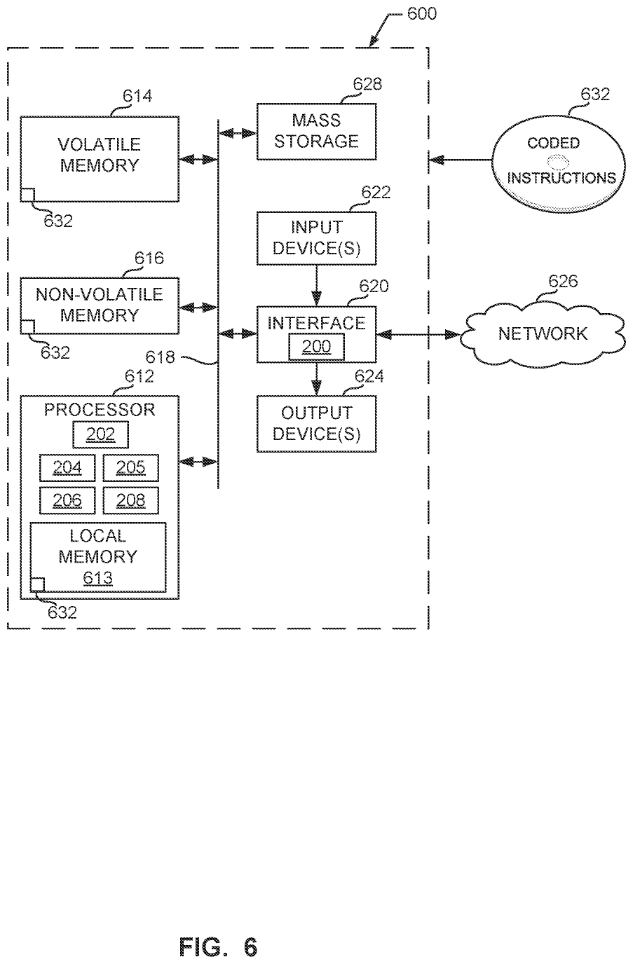

Flowcharts representative of example hardware logic, machine readable instructions, hardware implemented state machines, and/or any combination thereof for implementing the example collector 108 and/or the example HFI 102 of FIGS. 1 and/or 2, and/or FIG. 3 are shown in FIGS. 4-5. The machine readable instructions may be one or more executable program or portion(s) of an executable program for execution by a computer processor such as the processor 612, 712 shown in the example processor platform 600, 700 discussed below in connection with FIGS. 6 and/or 7. The program may be embodied in software stored on a non-transitory computer readable storage medium such as a CD-ROM, a floppy disk, a hard drive, a DVD, a Blu-ray disk, or a memory associated with the processor 612, 712, but the entire program and/or parts thereof could alternatively be executed by a device other than the processor 612, 712 and/or embodied in firmware or dedicated hardware. Further, although the example program is described with reference to the flowcharts illustrated in FIGS. 4-5, many other methods of implementing the example collector 108, and/or the example HFI 102 of FIGS. 1 and/or 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein. In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

As mentioned above, the example process of FIGS. 4-5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in that information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

FIG. 4 is an example flowchart 400 representative of example machine readable instructions that may be executed in the example CPU 103 to implement the example collector 108 of FIGS. 1 and/or 2 to dynamically adjust a performance polling protocol to conserve CPU resources (e.g., the example cache 120 and/or the example processor core(s) 122). Although the flowchart 400 of FIG. 4 is described in conjunction with the example collector 108 of FIGS. 1 and/or 2, other type(s) of collector(s), and/or other type(s) of processor(s) may be utilized instead.

At block 402, the example performance data comparator 201 collects (e.g., via the example on-chip interface 200) performance data of the example application 104. For example, the on-chip interface 200 polls counter values from the example event counters 118 of the example HFI 102 corresponding to communication events occurring at the example HFI 102. Because the application 104 corresponds to the instructions that cause the communication events, tracking the event counts corresponds to the performance of the example application 104. At block 404, the example performance data comparator 201 processes the collected performance data. The example performance data comparator 201 processes the collected performance data to determine if there is a period of low activity (e.g., low communication activity). Periods of low activity periodically occur in bulk-synchronous HPC applications, for example. The example performance data comparator 201 may determine that there is a period of low activity if less than a threshold number of communication operations occurred within a duration of time.

At block 406, the example performance data comparator 201 determines if the example collector 108 should enter sleep mode. For example, if the performance data comparator 201 determines that there is a period of low activity based on current and/or previous polled data, the performance data comparator 201 determines that sleep mode should be entered. Additionally or alternatively, the example performance data comparator 201 may determine that sleep mode should be entered based on a triggered signal from the example application 104 and/or another component.

If the example performance data comparator 201 determines that the collector 108 should not enter sleep mode (block 406: NO), the process returns to block 402 and the example collector 108 continues to poll performance data at a frequency corresponding to wake-up mode. If the example performance data comparator 201 determines that the collector 108 should enter sleep mode (block 406: YES), the example instructions generator 202 determines which and/or how many event(s) to correspond to a wake-up trigger (block 407). For example, the instructions generator 202 may determine that the collector 108 should be awaken in response to three message arrivals at the HFI 102, five messages have been transmitted by the HFI 102, and/or 100 bytes have been received by the HFI 102. The wake up parameters may be based on user and/or manufacturer preferences.

At block 408, the example instructions generator 202 obtains event count(s) of the event counter(s) 118 (e.g., via the example on-chip interface 200) corresponding to the events to be tracked. For example, if an event to be tracked corresponds to a number of received messages, and the corresponding event counter is currently at a count of one hundred, the example instructions generator 202 identifies the count as one hundred. At block 409, the example adder 204 determines the threshold count(s) by adding the wake-up count to the identified count of the corresponding event counters 118. For example, if the wake up count is five and the current count of the corresponding event counter 118 is one hundred, the example adder 204 determines the threshold count for the corresponding counter to be one-hundred five.

At block 410, the example instructions generator 202 allocates address(es) in the example user memory space 110 to correspond to a triggered operation(s). As described above, the triggered operation will instruct the example HFI 102 to write to a selected address in the user memory space 110 in response to the number of selected events occurring. Accordingly, the example instructions generator 202 allocates the memory space to be able to determine when the HFI 102 has written to the memory, thereby triggering a wake-up of the collector 108. At block 412, the example memory monitor 206 reads the initial data stored at the allocated address(es). In some examples, the memory monitor 206 may write (e.g., using the example memory interface 208) a preset initial value to the allocated address(es) to ensure that the HFI does not write the same data as the initial data.

At block 414, the example on-chip interface 200 transmits write back instructions (e.g., one or more data packet(s) including the triggered operation(s), the allocated memory address location(s), and the wake-up parameters (e.g., the type of events and/or event counters to trigger wake-up, the threshold count(s), etc.)) to the example HFI 102. At block 416, the frequency selector 205 enters sleep mode by reducing the polling frequency from a first frequency (e.g., an awake polling frequency) to a second frequency (e.g., a sleep polling frequency). As described above, reducing or otherwise halting performance polling conserves CPU resources.

At block 418, the example memory monitor 206 reads the current data at the allocated address(es) by instructing the memory interface 208 to read the value stored at the allocated address. At block 420, the example memory monitor 206 determines if the current data (e.g., the data read from the allocated memory address(es) at block 418) is the same as the initial data (e.g., the data read from the allocated memory address(es) at block 412). As described above, if the event counter(s) associated with the triggered operations reach the threshold value, the example HFI 102 writes data to the allocated memory address of the user memory space 110. Accordingly, the current data being the different from the initial data corresponds to a wake-up trigger for the collector 108.

If the example memory monitor 206 determines that the current data is the same as the initial data (block 420: YES), the process returns to block 418 to continue to monitor the data in the allocated memory address(es) and the collector 108 remains in sleep mode. If the example memory monitor 206 determines that the current data is not the same as (e.g., is different than) the initial data (block 420: NO), the example frequency selector 205 wakes the collector 108 up by increasing the polling frequency from the second frequency to the first frequency and/or any other frequency faster than the second frequency (block 422) and the process returns to block 402 to collect performance data, thereby waking up the collector 108.

FIG. 5 is an example flowchart 500 representative of example machine readable instructions that may be executed by the example implementation of the example HFI 102 of FIG. 1 to perform a triggered operation based on instructions from the example collector 108 of FIG. 1. Although the flowchart 500 of FIG. 5 is described in conjunction with the example HFI 102 of FIG. 1, other type(s) of HFI(s), and/or other type(s) of processor(s) may be utilized instead.

At block 502, the communication interface 300 of the example triggered operations circuitry 112 obtains write back instructions from the collector 108 corresponding to a triggered put operation. As described above, the example collector 108 may transmit the write back instructions corresponding to a triggered put operation when the collector 108 enters into a sleep-mode. At block 504, the example triggered operations circuitry 112 determines the event(s) to be tracked, the threshold count(s) (e.g., the count of one or more event count(s) that must occur before the triggered operation is executed to wake up the collector 108), and/or the corresponding memory address location(s) for writing once the wake-up count(s) is/are satisfied based on the obtained write back instructions.

At block 506, the example instructions queue 302 of the example triggered operation circuitry 112 stores the triggered operation(s) specified in the obtained data packet(s). As described above, the instructions queue 302 stores the triggered operation(s) (e.g., triggered put operation(s) or triggered atomic operation(s)) until the count(s) of the event counter(s) 118 corresponding to the determined event(s) satisfies the wake-up count(s). At block 510, the example threshold register 308 stores the threshold count(s) specified in the write back instructions.

At block 512, the example communication engine 116 determines if an event corresponding to one of the example event counters 118 has occurred. If the example communication engine 116 determines that an event corresponding to one of the example event counters 118 has not occurred (block 512: NO), the example communication engine 116 continues to monitor events. If the example communication engine 116 determines that an event corresponding to one of the example event counters 118 occurred (block 512: YES), the example communication engine 116 increments the corresponding event counter 118 (block 514).

At block 516, the example comparator 310 of the triggered operations circuitry 112 determines if the current count of the corresponding event counter(s) 118 (e.g., the event counter(s) corresponding to the events identified in the obtained data packed) reached the trigger threshold. If the comparator 310 determines that the current count of the corresponding event counter(s) 118 does not satisfy the threshold count(s) (block 516: NO), the process returns to block 512 until one or more of the corresponding event counters 118 satisfies the threshold count(s). If the comparator 310 determines that the current count of the corresponding event counter(s) 118 satisfies the threshold count(s) (block 516: YES), the example triggered operations circuitry 112 launches the example queued operation(s) (block 518) by popping the queued put operation(s) and transmitting the put operation(s) to the example command processor 114. At block 520, the example command processor 114 executes the triggered operation by instructing the example communication engine 116 to write data (e.g., using a DMA/RDMA operation) to the allocated memory address(es) (e.g., specified in the put operation of the obtained write back instructions) of the example user memory space 110.

FIG. 6 is a block diagram of an example processor platform 600 structured to execute the instructions of FIG. 4 to implement the example collector 108 of FIG. 1 and/or 2. The processor platform 600 can be, for example, a server, a personal computer, a workstation, a self-learning machine (e.g., a neural network), a mobile device (e.g., a cell phone, a smart phone, a tablet such as an iPad™), or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example on-chip interface 200, the example performance data comparator 201, the example instructions generator 202, the example frequency selector 205, the example memory monitor 206, and the example memory interface 208.

The processor 612 of the illustrated example includes a local memory 613 (e.g., a cache). In some examples, the local memory 613 implements the example cache 120 of FIG. 1. The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller. In some examples, the main memory 614, 616 and/or the example local memory 613 implements the example memory 109 of FIG. 1.

The processor platform 600 of the illustrated example also includes an interface circuit 620. The interface circuit 620 may be implemented by any type of interface standard, such as an Ethernet interface, a universal serial bus (USB), a Bluetooth® interface, a near field communication (NFC) interface, and/or a PCI express interface.

In the illustrated example, one or more input devices 622 are connected to the interface circuit 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular telephone system, etc. In the example of FIG. 6, the interface circuit 620 implements the example on-chip interface 200.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives.

The machine executable instructions 632 of FIG. 6 may be stored in the mass storage device 628, in the volatile memory 614, in the non-volatile memory 616, and/or on a removable non-transitory computer readable storage medium such as a CD or DVD.

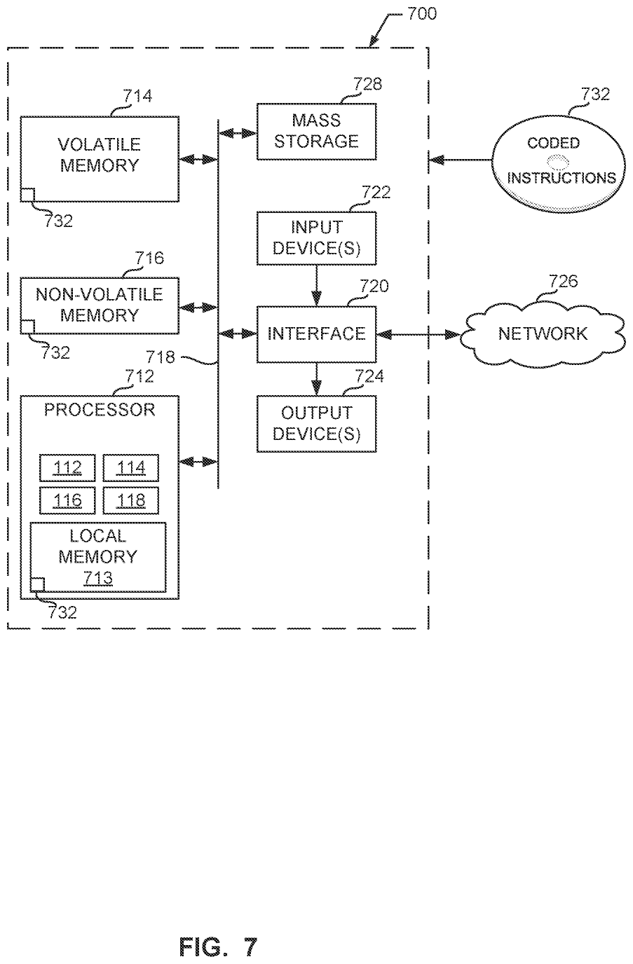

FIG. 7 is a block diagram of an example processor platform 700 structured to execute the instructions of FIG. 5 to implement the example HFI 102 of FIG. 1. The processor platform 700 can be, for example any type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example triggered operations circuitry 112, the example command processor 114, the example communication engine 116, and the example event counters 118.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIG. 5 may be stored in the mass storage device 728, in the volatile memory 714, in the non-volatile memory 716, and/or on a removable non-transitory computer readable storage medium such as a CD or DVD.

Example methods, apparatus, systems, and articles of manufacture to collect performance data collection in cooperation with a host fabric interface are disclosed herein. Further examples and combinations thereof include the following: Example 1 includes an apparatus to collect performance data collection in cooperation with a host fabric interface, the apparatus comprising a performance data comparator of a source node to collect the performance data of an application of the source node from the host fabric interface at a polling frequency, an interface to transmit a write back instruction to the host fabric interface, the write back instruction to cause data to be written to a memory address location of memory of the source node to trigger a wake up mode, and a frequency selector to start the polling frequency to a first polling frequency for a sleep mode, and increase the polling frequency to a second polling frequency in response to the data in the memory address location identifying the wake mode.

Example 2 includes the apparatus of example 1, further including an instructions generator to generate the write back instruction corresponding to a threshold number of events.

Example 3 includes the apparatus of example 2, wherein the write back instruction is to cause host fabric interface to write the data to the memory address in response to the threshold number of events.

Example 4 includes the apparatus of example 1, wherein the memory is accessible to the application.

Example 5 includes the apparatus of example 1, wherein the first polling frequency is zero.

Example 6 includes the apparatus of example 1, further including a memory monitor to monitor the data at the memory address location changes.

Example 7 includes the apparatus of example 6, wherein the memory monitor is to monitor the data at the memory address location by reading an initial value of the memory address location, reading a current value of the memory address location, and identifying that the data in the memory address location has changed when the initial value is different than the current value.

Example 8 includes the apparatus of example 6, wherein the memory monitor is to monitor the memory address location by writing an initial value to the memory address location of the memory, reading a current value stored at the memory address location, and identifying that the data in the memory address location has changed when the initial value is different than the current value.

Example 9 includes a non-transitory computer readable storage medium comprising instructions which, when executed, cause a processor to at least collect performance data of an application of a source node at a polling frequency, transmit a write back instruction to host fabric interface, the write back instruction to cause data to be written to a memory address location of memory of the source node to trigger a wake mode, start the polling frequency to a first polling frequency for a sleep mode, and increase the polling frequency to a second polling frequency in response to the data in the memory address location identifying the wake mode.

Example 10 includes the non-transitory computer readable storage medium of example 9, wherein the instructions cause the processor to generate the write back instructions corresponding to a threshold number of events.

Example 11 includes the non-transitory computer readable storage medium of example 10, wherein the write back instructions is to cause a host fabric interface to write the data to the memory address location in response to the threshold number of events.

Example 12 includes the non-transitory computer readable storage medium of example 9, wherein the memory is accessible to the application.

Example 13 includes the non-transitory computer readable storage medium of example 9, wherein the first polling frequency is zero.

Example 14 includes the non-transitory computer readable storage medium of example 9, wherein the instructions cause the processor to monitor data in the memory address location.

Example 15 includes the non-transitory computer readable storage medium of example 14, wherein the instructions cause the processor to monitor the data at the memory address location by reading an initial value of the memory address location, reading a current value of the memory address location, and identifying that the data in the memory address location has changed when the initial value is different than the current value.

Example 16 includes the non-transitory computer readable storage medium of example 14, wherein the instructions cause the processor to monitor the memory address location by writing an initial value to the memory address location of the memory, reading a current value stored at the memory address location, and identifying that the data in the memory address location has changed when the initial value is different than the current value.

Example 17 includes a source node comprising a processor, memory, and a collector to collect performance data corresponding to a high performance computing application to be executed by the processor, transmit a write back instruction to a host fabric interface, the write back instruction to cause the host fabric interface to initiate an update of a memory address location of the memory of the source node, enter into a sleep mode, and wake up from the sleep mode in response to the update to the memory address location.

Example 18 includes the source node of example 17, wherein the write back instruction is to cause a write operation to the memory address location of the memory in response to a threshold number of events.

Example 19 includes the source node of example 17, wherein the collector is to monitor the data at the memory address location for changes.

Example 20 includes the source node of example 19, wherein the collector is to monitor the data at the memory address location by reading an initial value of the memory address location, reading a current value of the memory address location, and identifying that the data in the memory address location has changed when the initial value is different than the current value.

Example 21 includes the source node of example 19, wherein the collector is to monitor the memory address location by writing an initial value to the memory address location of the memory, reading a current value stored at the memory address location, and identifying that the data in the memory address location has changed when the initial value is different than the current value.

Example 22 includes an apparatus to collect performance data collection in cooperation with a host fabric interface, the apparatus comprising means for collecting the performance data of an application of the source node from the host fabric interface at a polling frequency, means for transmitting a write back instruction to the host fabric interface, the write back instruction to cause data to be written to a memory address location of memory of the source node to trigger a wake up mode, and means for starting the polling frequency to a first polling frequency for a sleep mode, and increasing the polling frequency to a second polling frequency in response to the data in the memory address location identifying the wake mode.

Example 23 includes the apparatus of example 22, further including means for generating the write back instruction corresponding to a threshold number of events.

Example 24 includes the apparatus of example 23, wherein the write back instruction is to cause host fabric interface to write the data to the memory address in response to the threshold number of events.

Example 25 includes the apparatus of example 22, wherein the memory is accessible to the application.

Example 26 includes the apparatus of example 22, wherein the first polling frequency is zero.

Example 27 includes the apparatus of example 22, further means for monitoring the data at the memory address location changes.

Example 28 includes the apparatus of example 27, wherein the means for monitoring is to monitor the data at the memory address location by reading an initial value of the memory address location, reading a current value of the memory address location, and identifying that the data in the memory address location has changed when the initial value is different than the current value.

Example 29 includes the apparatus of example 27, wherein the means for monitoring is to monitor the memory address location by writing an initial value to the memory address location of the memory, reading a current value stored at the memory address location, and identifying that the data in the memory address location has changed when the initial value is different than the current value.

From the foregoing, it will be appreciated that example methods, apparatus and articles of manufacture have been disclosed herein to improve performance data collection in high performance computing applications. Disclosed methods, apparatus and articles of manufacture improve performance data collection for HPC applications by leveraging the possible capability of an HFI to wake up a collector from sleep mode. For example, although HFIs are typically structured and/or programmed to forward data to other nodes in a HPC system by writing data into memory of the other nodes for collective communication operations, examples disclosed herein utilize a collector of a node to instruct the HFI to initiate a trigger put operation (e.g., a write data operation) in the memory of the node that includes the sleeping collector and requested the write back (as opposed to another node in the HFI). In sleep mode, the collector monitors a specified memory address location to identify when the memory address location is written to a trigger value, thereby corresponding to the condition being satisfied (e.g., the one or more events occurring). In response to the collector identifying that the data in the memory address location has been updated, the collector then wakes up and increases the polling frequency or restarts the polling process. Because monitoring one or more memory addresses uses less CPU resources than polling the event counters directly, examples disclosed herein significantly reduce the amount of CPU resources needed to perform performance data collection of HPC applications. Disclosed methods, apparatus and articles of manufacture are accordingly directed to one or more improvement(s) in the functioning of a computer.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A source node comprising:
storage;
network interface circuitry to write a value to an address of the storage;
machine readable instructions; and
processor circuitry to execute the machine readable instructions to:
obtain performance data written by the network interface circuitry at (1) a first polling frequency or (2) a second polling frequency based on the value stored at the address, the second polling frequency higher than the first polling frequency.

2. The source node of claim 1, wherein:
the processor circuitry is to transmit a write back instruction to the network interface circuitry, the write back instruction including the address of the storage; and
the network interface circuitry to determine the address of the storage based on the write back instruction.

3. The source node of claim 2, wherein the write back instruction includes a threshold count for an event to monitor, the network interface circuitry is to write the value to the address of the storage in response to a count corresponding to the event reaching the threshold count.

4. The source node of claim 1, wherein the first polling frequency corresponds to a sleep mode and the second polling frequency corresponds to an awake mode.

5. The source node of claim 1, wherein the storage is accessible to the processor circuitry.

6. The source node of claim 1, wherein the first polling frequency is zero.

7. The source node of claim 1, wherein the processor circuitry is to monitor the value at the address by:
reading an initial value stored at the address;
reading a current value stored at the address; and
identifying that the value stored at the address has changed when the initial value is different than the current value.

8. The source node of claim 1, wherein the processor circuitry is to monitor the value at the address by:
writing an initial value to the address of the storage;
reading a current value stored at the address; and
identifying that the value stored at the address has changed when the initial value is different than the current value.

9. At least one non-transitory computer readable medium comprising instructions which, when executed, cause one or more processors to at least:
instruct network interface circuitry to write a value to a location of a storage; and
obtain performance data written by network interface circuitry at (1) a first polling frequency or (2) a second polling frequency based on the value stored at the location, the second polling frequency higher than the first polling frequency.

10. The at least one computer readable medium of claim 9, wherein the instructions cause the one or more processors to at least:
cause transmission of a write back instruction to the network interface circuitry, the write back instruction including the location of the storage; and
determine the location of the storage based on the write back instruction.

11. The at least one computer readable medium of claim 10, wherein the write back instruction includes a threshold count for an event to monitor, the instructions to cause the one or more processors to write the value to the location of the storage in response to a count corresponding to the event reaching the threshold count.

12. The at least one computer readable medium of claim 9, wherein the first polling frequency corresponds to a sleep mode and the second polling frequency corresponds to an awake mode.

13. The at least one computer readable medium of claim 9, wherein the storage is accessible to the one or more processors.

14. The at least one computer readable medium of claim 9, wherein the first polling frequency is zero.

15. The at least one computer readable medium of claim 9, wherein the instructions cause the one or more processors to monitor the value at the location by:
reading an initial value stored at the location;
reading a current value stored at the location; and
identifying that the value stored at the location has changed when the initial value is different than the current value.

16. The at least one computer readable medium of claim 9, wherein the instructions cause the one or more processors to monitor the value at the location by:
writing an initial value to the location of the storage;
reading a current value stored at the location; and
identifying that the value stored at the location has changed when the initial value is different than the current value.

17. A compute node comprising:
storage;
machine readable instructions; and
processor circuitry to execute the machine readable instructions to:
output a write back instruction to interface circuitry, the write back instruction to identify (a) an event type to be monitored by the interface circuitry, (b) a threshold, and (c) an address of the storage; and
poll the interface circuitry at a rate based on a value at the address of the storage.

18. The compute node of claim 17, wherein the write back instruction includes data, the interface circuitry to write the data to at the address of the storage.

19. The compute node of claim 17, wherein the write back instruction causes the interface circuitry to write data at the address of the storage after a count corresponding to the event type reaches the threshold.

20. The compute node of claim 17, wherein the processor circuitry is to:
poll the interface circuitry at a first rate after outputting the write back instruction; and
poll the interface circuitry at a second rate higher than the first rate in response to when the value at the address of the storage changes from a first value to a second value.

21. The compute node of claim 20, wherein the first rate is zero.

22. A non-transitory computer readable medium comprising instructions which, when executed, cause one or more processors to at least:
output a write back instruction to interface circuitry, the write back instruction to identify (a) an event type to be monitored by the interface circuitry, (b) a threshold, and (c) a location of storage; and
poll the interface circuitry at a rate based on a value at the location of the storage.

23. The computer readable medium of claim 22, wherein the write back instruction includes data for the interface circuitry to write to at the location of the storage.

24. The computer readable medium of claim 22, wherein the write back instruction causes the interface circuitry to write data at the location of the storage after a count corresponding to the event type reaches the threshold.

25. The computer readable medium of claim 22, wherein the instructions cause the one or more processors to:
poll the interface circuitry at a first rate after outputting the write back instruction; and
poll the interface circuitry at a second rate in response to when the value at the location of the storage changes from a first value to a second value.
